(19) United States
(12) Patent Application Publication
(10) Pub. No.: US 2016/0373554 A1
(43) Pub. Date: Dec. 22, 2016

(54) COMPUTER-READABLE RECORDING MEDIUM, WEB ACCESS METHOD, AND WEB ACCESS DEVICE

(71) Applicant: FUJITSU LIMITED, Kawasaki-shi (JP)

(72) Inventors: Yuuki NAGAO, Kawasaki (JP); Takafumi OHTA, Shinagawa (JP); Yutaka YAMANAKA, Tagata (JP)

(73) Assignee: FUJITSU LIMITED, Kawasaki-shi (JP)

(21) Appl. No.: 15/180,253

(22) Filed: Jun. 13, 2016

(30) Foreign Application Priority Data
Jun. 17, 2015 (JP) 2015-122313

(51) Int. Cl. H04L 29/08

(52) U.S. Cl. CPC H04L 67/36; H04L 67/16; H04L 67/02

(57) ABSTRACT

An information processing apparatus acquires page information related to a web page displayed on a web browser. Subsequently, the information processing apparatus generates starting point information related to an access to the web page, from access information of a series of web pages that are accessed and displayed on the web browser through the web page. Then, the information processing apparatus stores page information of the web page associated with the starting point information.

### CROSS-REFERENCE TO RELATED APPLICATION

This application is based upon and claims the benefit of priority of the prior Japanese Patent Application No. 2015-122313, filed on Jun. 17, 2015, the entire contents of which are incorporated herein by reference.

### FIELD

The embodiments discussed herein are related to a computer-readable recording medium having stored therein a web access program, a web access method, and a web access device.

### BACKGROUND

A web browser loads a website described in HyperText Markup Language (HTML) or the like and displays the website. Furthermore, the web browser has a bookmark function and a browsing history storage function to allow a website browsed in the past to be easily accessed again.

For example, the web browser stores a uniform resource locator (URL) or the like of a loaded website in a browsing history folder. Furthermore, upon accepting an instruction to add a loaded website to bookmark, the web browser stores a URL or a title of the website in a bookmark folder.

In recent years, a device such as a smartphone is also provided with a web browser having the same functions as those of a web browser installed in a personal computer, and network access using the device is widely used.

Patent Literature 1: Japanese Laid-open Patent Publication No. 2011-90546

However, it is difficult for a user to search for a desired web page from URLs or titles registered in the bookmark or the browsing history. Furthermore, the number of items registered in the bookmark and the browsing history increases with an increase in use of the web browser, so that the convenience of the user is reduced.

### SUMMARY

According to an aspect of an embodiment, a non-transitory computer-readable recording medium stores therein an access information storing program that causes a computer to execute a process. The process includes acquiring page information related to a web page displayed on a web browser; generating starting point information related to an access to the web page, from access information of a series of web pages that are accessed and displayed on the web browser through the web page; and storing page information of the web page associated with the starting point information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of an overall configuration of a system according to a first embodiment;

FIG. 2 is a functional block diagram illustrating a functional configuration of an information processing apparatus according to the first embodiment;

FIG. 3 is a diagram illustrating an example of information stored in a determination information DB according to the first embodiment;

FIG. 4 is a diagram illustrating an example of information stored in a history information DB according to the first embodiment;

FIG. 5 is a diagram for explaining an example of history registration;

FIG. 6 is a diagram for explaining an example of history search;

FIG. 7 is a flowchart illustrating the flow of a website display process;

FIG. 8 is a flowchart illustrating the flow of a history registration process;

FIG. 9 is a flowchart illustrating the flow of a search process; and

FIG. 10 is a diagram for explaining a hardware configuration example.

### DESCRIPTION OF EMBODIMENTS

Preferred embodiments will be explained with reference to accompanying drawings. The present invention is not limited by the embodiments below. Furthermore, the embodiments may be combined appropriately as long as no contradiction is derived.

### [a] First Embodiment

Overall Configuration

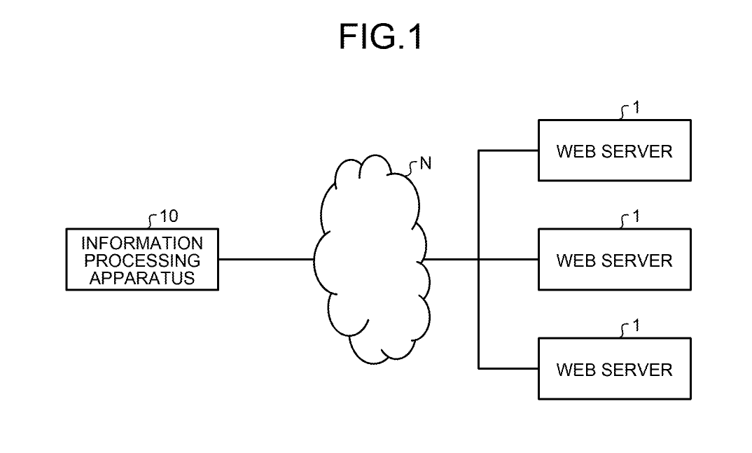

FIG. 1 is a diagram illustrating an example of an overall configuration of a system according to a first embodiment. As illustrated in FIG. 1, the system includes a plurality of web servers 1 and an information processing apparatus 10 that are connected to one another via a network N.

As the network N, any kind of communication network, such as the Internet, a local area network (LAN), or a virtual private network (VPN), may be used regardless of whether it is wired or wireless.

Each of the web servers 1 is a server device that provides a website to a user. The website includes a web page described in a markup language, such as HTML, or the like, and includes an image, a moving image, or the like.

The information processing apparatus 10 is a web access device that accesses the web servers 1 by using a web browser, loads websites provided by the web servers 1, and displays the websites on a display or the like. The information processing apparatus 10 is a client terminal used by a user. As an example of the information processing apparatus 10, a portable personal computer, a desktop personal computer, or the like may be used. Furthermore, as a portable terminal, for example, a mobile communication terminal, such as a tablet terminal, a smartphone, a mobile phone, or a personal handyphone system (PHS), or the like may be used, in addition to the above-described personal computer.

In this state, the information processing apparatus 10 acquires page information related to a website displayed on the web browser. The information processing apparatus 10 generates starting point information related to an access to the web page, from access information of a series of web sites that are accessed and displayed on the web browser through the website. The information processing apparatus 10 stores page information of the web site associated with the starting point information.

That is, the information processing apparatus 10 stores, for each browsed website, meta-information on the website associated with starting point information indicating a search word or an application name that serves as a starting point of transition to the website. Consequently, it becomes possible to search for a browsing history with respect to each starting point information, so that it is possible to improve the convenience for the user to access a website that has been accessed in the past.

Functional Configuration

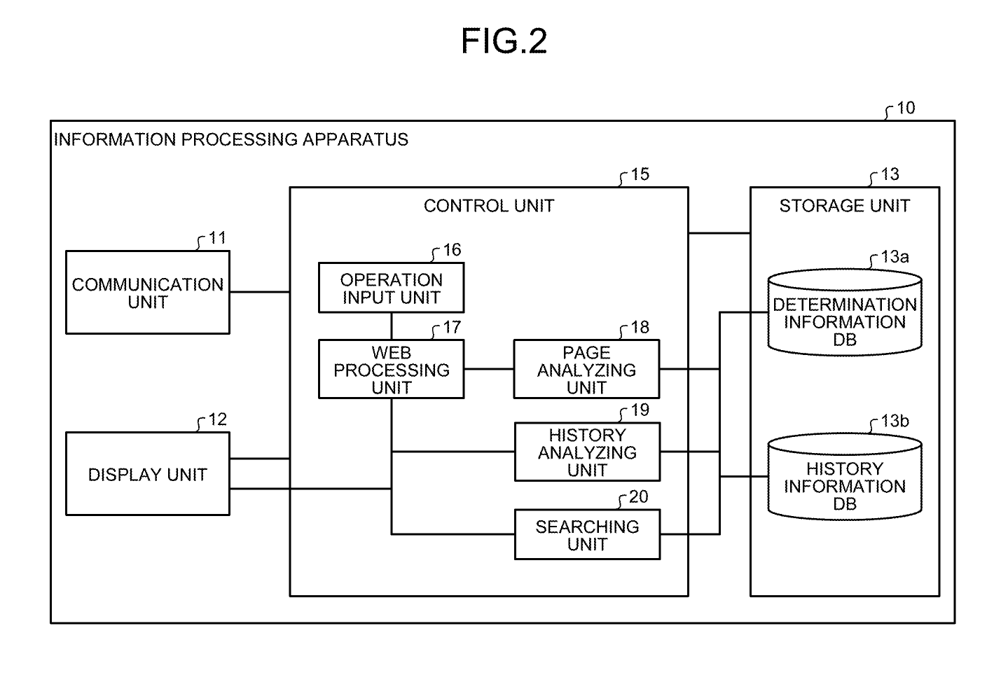

FIG. 2 is a functional block diagram illustrating a functional configuration of the information processing apparatus according to the first embodiment. As illustrated in FIG. 2, the information processing apparatus 10 includes a communication unit 11, a display unit 12, a storage unit 13, and a control unit 15.

The communication unit 11 is implemented by, for example, a network interface card (NIC) or the like. The communication unit 11 is a communication interface that is connected to the web server 1 via the network N by wire or wireless, and controls communication of information with the web server 1. The display unit 12 is a display, a touch panel, or the like, and is a display device that displays a website loaded by the web browser.

The storage unit 13 is a storage device that stores therein a program to be executed by the control unit 15 and data, and is a memory, a hard disk, or the like, for example. The storage unit 13 stores therein a determination information database (DB) 13a and a history information DB 13b.

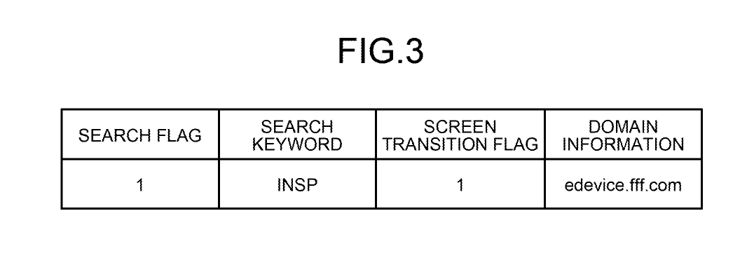

The determination information DB 13a is a database for storing information for determining whether a displayed website is included in a series of associated sites, that is, information used to determine an action flow. FIG. 3 is a diagram illustrating an example of information stored in the determination information DB according to the first embodiment. As illustrated in FIG. 3, the determination information DB 13a stores “a search flag, a search keyword, a screen transition flag, and domain information” in an associated manner.

The “search flag” stored here is information indicating whether a website has been searched for, and is set to “1” when the website has been searched for and to “0” when the website has not been searched for. The “search flag” can be specified by an input via a software keyboard, pressing of a retrieve button, a search button, or the like, a URL of the website, or the like. The “search keyword” is a search word input in a search engine or the like displayed on the web browser.

The “screen transition flag” is information indicating whether screen transition of the web browser has been performed, and is set to “1” when the screen transition has been performed and to “0” when the screen transition has not been performed. The “screen transition flag” can be specified by pressing of a link (anchor tag). The “domain information” is domain information on the website, and a domain of the website is registered when the screen transition flag is enabled.

In the example in FIG. 3, it is indicated that “INSP” is input as a search keyword, a search is enabled, screen transition is enabled, and domain information is “edevice.fff.com”. Incidentally, the pieces of the information are reset by the control unit 15 or the like when a URL of a website is directly input in an address bar and the website is displayed, when domain information is different than before the screen transition, when the web browser is closed, or the like.

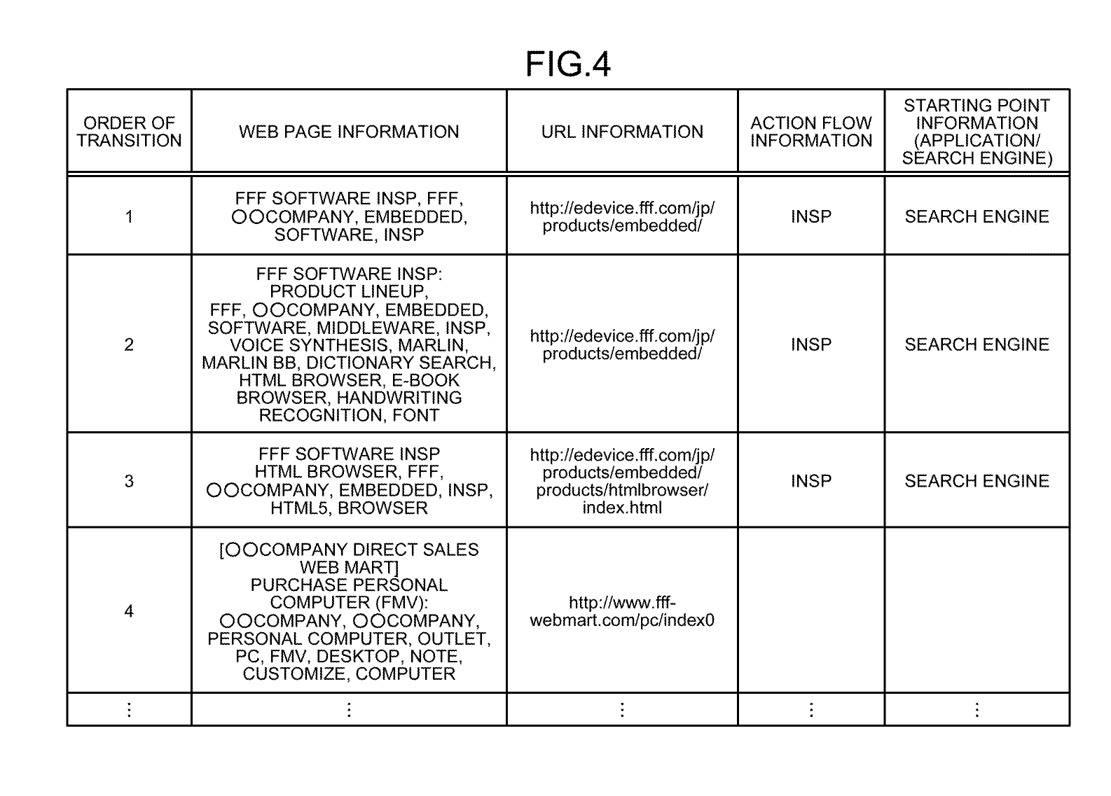

The history information DB 13b is a database for storing a browsing history of a website. FIG. 4 is a diagram illustrating an example of information stored in the history information DB 13b according to the first embodiment. As illustrated in FIG. 4, the history information DB 13b stores “order of transition, web page information, URL information, action flow information, and starting point information” in an associated manner.

The “order of transition” is the order of transition of websites. The “web page information” is information for specifying a title or contents of a website. The “web page information” corresponds to information described in a “title tag” or a “meta tag” of the website.

The “action flow information” is information that has led to transition to a website, and is information for associating accesses to the website. For example, a search keyword input in a search engine is stored in the “action flow information”. In the “action flow information”, a search keyword is registered when the search flag and the screen transition flag are enabled and the domain information is identical in FIG. 3. The “starting point information” is information for specifying a starting point of an action flow. In the “starting point information”, a search engine in which a search keyword is input or a name of an application that has activated a web browser to access to the website is stored.

The first row in FIG. 4 will be described as an example. The first row indicates information on a website that is retrieved when “INSP” is input in a search engine. It is indicated that contents including character strings “FFF Software INSP, FFF, ∘∘ company, embedded, software, INSP” are described in the website, and the URL is “http://edevice.fff.com/jp/products/embedded/”.

Incidentally, the information stored in the history information DB 13b is one example, and it may be possible to store, for example, a favicon that is an icon image associated with a website, folder information, a browsing date, or the like.

The control unit 15 is a processing unit that controls the entire information processing apparatus 10, and is, for example, a processor or the like. The control unit 15 includes an operation input unit 16, a web processing unit 17, a page analyzing unit 18, a history analyzing unit 19, and a searching unit 20. Incidentally, the operation input unit 16, the web processing unit 17, the page analyzing unit 18, the history analyzing unit 19, and the searching unit 20 are examples of electronic circuits included in the processor or processes performed by the processor.

The operation input unit 16 is a processing unit that accepts input of a user operation. For example, the operation input unit 16 accepts an operation of activating a web browser, an operation of activating an application of a social networking service (SNS) or the like. Furthermore, the operation input unit 16 accepts various operations for a displayed website via the web browser. The operation input unit 16 outputs the accepted information to the web processing unit 17. Incidentally, if an icon of an application is clicked, the operation input unit 16 specifies this operation as an operation of activating an application specified by the icon and executes the application.

The web processing unit 17 is a processing unit that analyzes the information accepted by the operation input unit 16 and performs various processes by using the web browser. Specifically, the web processing unit 17 activates the web browser, accesses an appropriate website, loads a web page, and displays the web page on the display unit 12. Furthermore, if a link or the like displayed on the web browser is selected, the web processing unit 17 accesses a link destination and performs screen transition.

For example, if an icon or the like of the web browser is selected, the web processing unit 17 specifies this operation as an operation of activating the web browser, activates the web browser, and displays a top screen (home screen). Furthermore, if a search button of a search engine displayed by using the web browser is clicked, the web processing unit 17 specifies this operation as a start of a search operation, performs a search, and displays a search result.

Moreover, if a button to access to a website displayed by a running application is clicked, the web processing unit 17 specifies this operation as an operation of activating the web browser and an operation of accessing the website. Then, the web processing unit 17 activates the web browser and displays a top screen (home screen).

The page analyzing unit 18 is a processing unit that analyzes the web page loaded by the web processing unit 17. Specifically, the page analyzing unit 18 acquires, from the website displayed on the display unit 12, site information related to the website or the like, and stores the site information or the like in the history information DB 13b.

For example, the page analyzing unit 18 specifies the order of transition of a displayed website by using a counter that counts transitions of web pages, and selects the “order of transition” in the history information DB 13b by using the specified information. Furthermore, the page analyzing unit 18 refers to a source code of the website, extracts a character string described in a “title tag”, a keyword described in a keyword content of a “meta name tag”, and a page description described in a description of the “meta name tag”, and stores the pieces of the extracted information in the “web page information” in the history information DB 13b. Moreover, the page analyzing unit 18 acquires a URL of the website and stores the URL in the “URL information” in the history information DB 13b.

The history analyzing unit 19 is a processing unit that generates starting point information for associating accesses from a start of transition to a website until display of the website, in accordance with a history of accesses before the website is accessed. Specifically, every time a website is displayed, the page analyzing unit 18 registers the web page information and the URL information in the history information DB 13b, and the history analyzing unit 19 registers the action flow information and the starting point information.

For example, if a website has transitioned, the history analyzing unit 19 determines whether the transition of the website is performed by a search engine or the website is activated by a different application. As one example, the history analyzing unit 19 determines whether the transition is performed by pressing of a link (anchor tag). If the transition is performed by pressing of the link, the history analyzing unit 19 determines that the transition is performed by the search engine and determines the starting point information as a “search engine”. In contrast, if the transition is not performed by pressing of the link, the history analyzing unit 19 determines that the transition is performed from an application and determines the starting point information as an “application name”.

Furthermore, if the website has transitioned, the history analyzing unit 19 determines whether an after-transition website has the same domain as a before-transition website. If the domain is identical, the history analyzing unit 19 determines that the transition of the website is in the same action flow. Consequently, the history analyzing unit 19 stores a history of the after-transition website in association with a history of the before-transition website.

In contrast, if the domain is not identical, the history analyzing unit 19 determines that the transition of the website is on a different action flow. Consequently, the history analyzing unit 19 stores the history of the after-transition website without associating the history of the before-transition website.

In general, when a research is performed by using a search engine, a user inputs a keyword in the search engine and selects and displays a website from a list of proposed links. Furthermore, transition from a displayed website to a different site is usually performed.

Therefore, the history analyzing unit 19 handles transition of a website as an “action flow” of a user's operation by using a keyword that has led to the transition as a “starting point”, and records the keyword serving as the starting point for websites in the same action flow. Consequently, it becomes possible to estimate that the websites in the action flow are associated with the keyword serving as the starting point, so that it becomes possible to provide a more accurate search result to a user at the time of search. As the “starting point” that leads to transition, a search keyword input in the search engine or additional information for activating a browser from a different application is used.

Furthermore, when a website is displayed from a result of the search engine and then transition to a different website is performed, and even if the different website does not have meta-information or the different website has completely different meta-information, the website can be associated with the keyword input in the search engine, which is useful. To record an action flow, a website obtained by transition from the search engine may transits to a website unrelated to the search keyword. Therefore, only when the domain of the website is identical to the domain of a page that is first obtained by transition from the search engine, the history analyzing unit 19 registers the search keyword for the website.

The searching unit 20 is a processing unit that provides an interface for searching for a browsing history of a website. Specifically, the searching unit 20 provides a search engine for a browsing history registered in the history information DB 13b. For example, upon accepting a search request, the searching unit 20 displays a screen for inputting a search keyword on the display unit 12. Then, the searching unit 20 searches for a history including information that matches the input search keyword from the history information DB 13b, and displays a search result on the display unit 12.

In this case, the searching unit 20 performs a search by giving priorities to the action flow information, the web page information, and the URL information in this order. That is, the searching unit 20 displays search results in order of a history for which the same character string as the search keyword is stored in the “action flow information”, a history for which the same character string as the search keyword is stored in the “web page information”, and a history for which the same character string as the search keyword is stored in the “URL information”.

Specific Example of History Registration

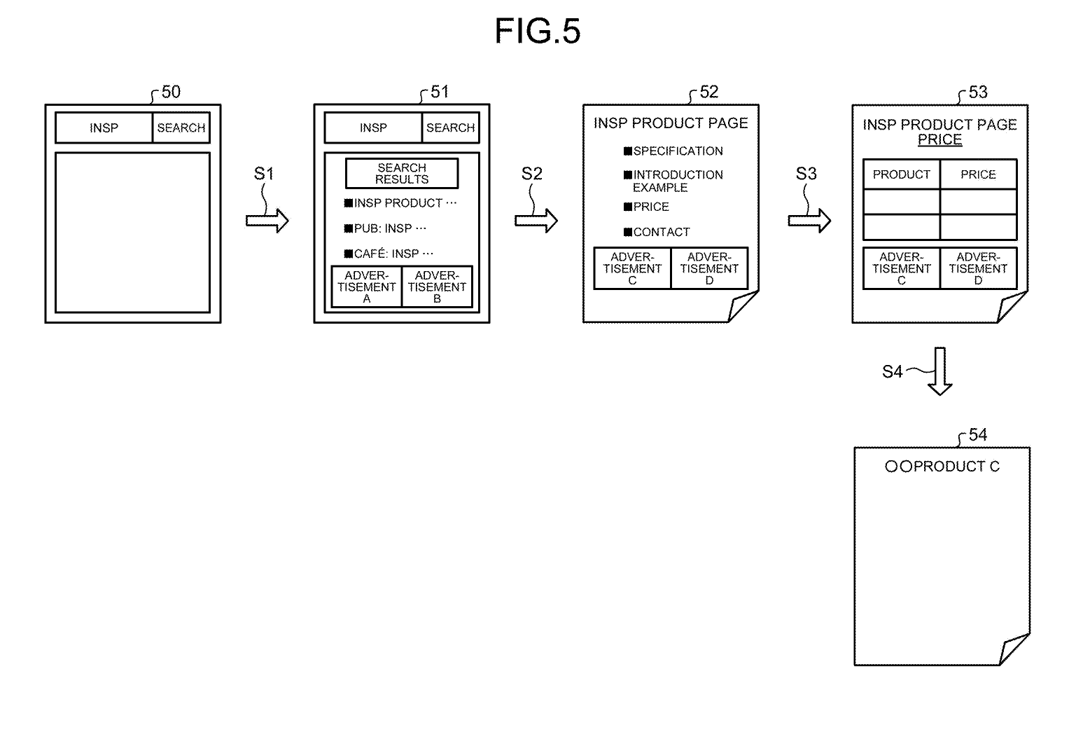

Next, a specific example of history registration will be described. FIG. 5 is a diagram for explaining an example of the history registration. As illustrated in FIG. 5, when a search keyword “INSP” is input and a search button is pressed in a search engine 50, a search result 51 for “INSP” is displayed on the display unit 12 (S1). In this case, the history analyzing unit 19 sets “INSP” in the search keyword in the determination information DB 13a and sets “1” in the search flag.

Subsequently, if a user selects “INSP product” from the search result 51 of “INSP”, an INSP product page 52 is displayed on the display unit 12 (S2). In this case, the history analyzing unit 19 sets “1” in the screen transition flag in the determination information DB 13a and sets a domain “edevice.fff.com” of the INSP product page 52 in the domain information in the determination information DB 13a.

Meanwhile, the page analyzing unit 18 extracts a title and meta-information from a source code of the INSP product page 52, and stores them in the “web page information” of a record with the “order of transition=1” in the history information DB 13b. Furthermore, the page analyzing unit 18 extracts a URL of the INSP product page 52 and stores the URL in the “URL information” of the record with the “order of transition=1” in the history information DB 13b.

Moreover, because the search flag is set to “1”, the history analyzing unit 19 stores the search engine in the “starting point information” of the record with the “order of transition=1” in the history information DB 13b. Furthermore, the history analyzing unit 19 stores the search keyword “INSP”, which is stored in the determination information DB 13a, in the “action flow information” of the record with the “order of transition=1” in the history information DB 13b.

Thereafter, if the user selects “price” in the INSP product page 52, an INSP product price page 53 is displayed on the display unit 12 (S3). The page analyzing unit 18 extracts a title and meta-information from a source code of the INSP product price page 53, and stores them in the “web page information” of a record with the “order of transition=2” in the history information DB 13b. Furthermore, the page analyzing unit 18 extracts a URL of the INSP product price page 53 and stores the URL in the “URL information” of the record with the “order of transition=2” in the history information DB 13b.

Meanwhile, because the screen transition flag is set to “1” in the determination information DB 13a, the history analyzing unit 19 determines an action flow. Specifically, the history analyzing unit 19 acquires a domain “edevice.fff.com” of the INSP product price page 53, and determines whether the domain is identical to the domain information in the determination information DB 13a. In this example, the domain is identical; therefore, the history analyzing unit 19 determines that the INSP product price page 53 is a website in the same action flow.

Therefore, the history analyzing unit 19 stores the search keyword “INSP”, which is stored in the determination information DB 13a, in the “action flow information” of the record with the “order of transition=2” in the history information DB 13b. Furthermore, the history analyzing unit 19 stores the “search engine” in the “starting point information” of the record with the “order of transition=2” in the history information DB 13b.

Thereafter, if the user selects an “advertisement C” in the INSP product price page 53, a page 54 of the advertisement C is displayed on the display unit 12 (S4). The page analyzing unit 18 extracts a title and meta-information from a source code of the page 54 of the advertisement C, and stores them in the “web page information” of a record with the “order of transition=3” in the history information DB 13b. Furthermore, the page analyzing unit 18 extracts a URL of the page 54 of the advertisement C and stores the URL in the “URL information” of the record with the “order of transition=3” in the history information DB 13b.

Meanwhile, because the screen transition flag is set to “1” in the determination information DB 13a, the history analyzing unit 19 determines an action flow. Specifically, the history analyzing unit 19 acquires a domain “CCC.com” of the page 54 of the advertisement C, and determines whether the domain is identical to the domain information in the determination information DB 13a. In this example, the domain is not identical; therefore, the history analyzing unit 19 determines that the page 54 of the advertisement C is a website in a different action flow. Therefore, the history analyzing unit 19 only stores the “search engine” in the “starting point information” of the record with the “order of transition=3” in the history information DB 13b.

Specific Example of Search

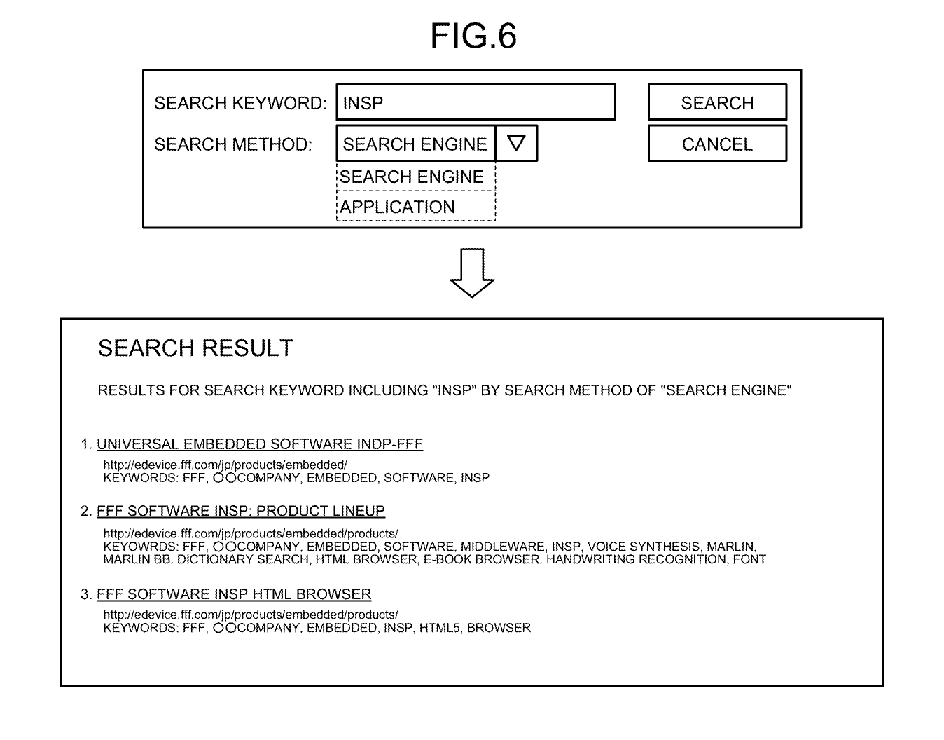

Next, a search for a browsing history will be described. FIG. 6 is a diagram for explaining an example of a history search. As illustrated in FIG. 6, upon receiving a search request, such as a selection of an icon of a search application, from a user, the searching unit 20 displays a search screen on the display unit 12. The search screen includes a search keyword input area, a search method setting area, a search button, and a cancel button.

A search keyword input area is an area for accepting a setting of a search keyword, and the search method setting area is an area for setting refinement of search targets. The search button is a button for requesting a start of a search, and the cancel button is a button for cancelling a process.

If “INSP” is set in the input area and when accepting a setting of a “search engine” as a search method, the searching unit 20 sets, as search targets, one or more pieces of history information for which the “search engine” is set in the starting point information in the history information DB 13b. Subsequently, the searching unit 20 refers to the “action flow information” of the search targets, searches for one or more pieces of history information for which “INSP” is set, and determines the pieces of the corresponding history information as display targets (high priority).

Subsequently, the searching unit 20 searches for one or more pieces of history information for which “INSP” is included in the web page information among pieces of the history information other than the pieces of the history information classified as the display targets (high priority), and determines the pieces of the corresponding history information as display targets (medium priority). Finally, the searching unit 20 searches for one or more pieces of history information for which “INSP” is included in the URL information among pieces of unclassified history information, and determines the pieces of the corresponding history information as display targets (normal priority).

Thereafter, the searching unit 20 displays search results of the pieces of the history information in order of the pieces of the history information of the display targets (high priority), the pieces of the history information of the display targets (medium priority), and the pieces of the history information of the display targets (normal priority). For example, the pieces of the history information of the display targets (high priority) are displayed at the head of the search results.

Furthermore, if a plurality of search keywords are specified, the searching unit 20 may preferentially display history information including a large number of search keywords. Moreover, the searching unit 20 may search for history information including a character string similar to a search word by performing various kinds of known synonym determination on the search word set as the search keyword and on the character string stored in each area in the history information DB 13b.

Flow of Processes

Next, processes performed by the information processing apparatus 10 will be described. In the following, a website display process, a history registration process, and a search process will be described.

Web Page Display Process

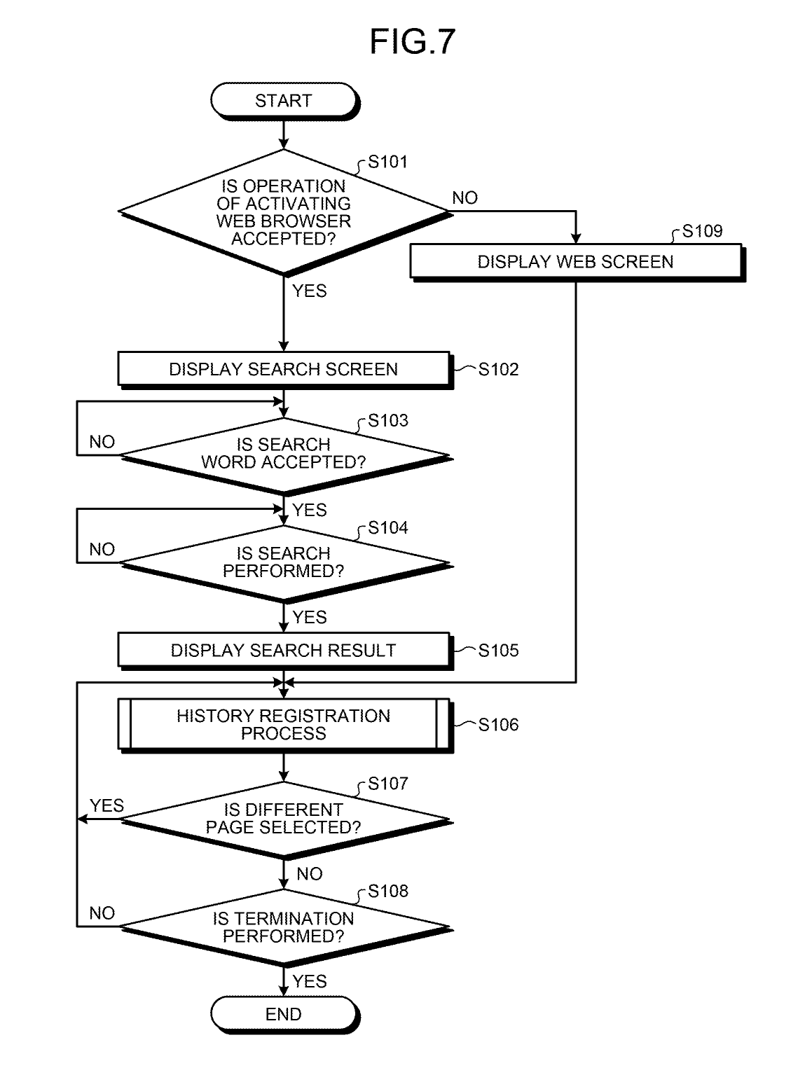

FIG. 7 is a flowchart illustrating the flow of the website display process. As illustrated in FIG. 7, when the web processing unit 17 accepts an operation of activating a web browser (YES at S101), the web processing unit 17 displays a search screen of a search engine (S102).

Subsequently, the web processing unit 17 accepts an input of a search word (YES at S103), and if a search button is pressed (YES at S104), the web processing unit 17 performs a search and displays a search result (S105). Subsequently, the page analyzing unit 18 and the history analyzing unit 19 performs the history registration process (S106).

If the history registration process ends, the web processing unit 17 determines whether transition to a different page is selected (S107). If transition to a different page is selected (YES at S107), the process at S106 is performed. In contrast, if transition to a different page is not selected (NO at S107), the web processing unit 17 determines whether termination of the process is performed (S108). If termination of the process is performed (YES at S108), the process is terminated. If termination of the process is not performed (NO at S108), the processes from S106 onward are performed.

Furthermore, at S101, if an operation of activating a web browser is not accepted (NO at S101), the operation input unit 16 determines that an operation of specifying activation of a website from an application is accepted, and displays a corresponding website (S109). Subsequently, the processes from S106 onward are performed.

History Registration Process

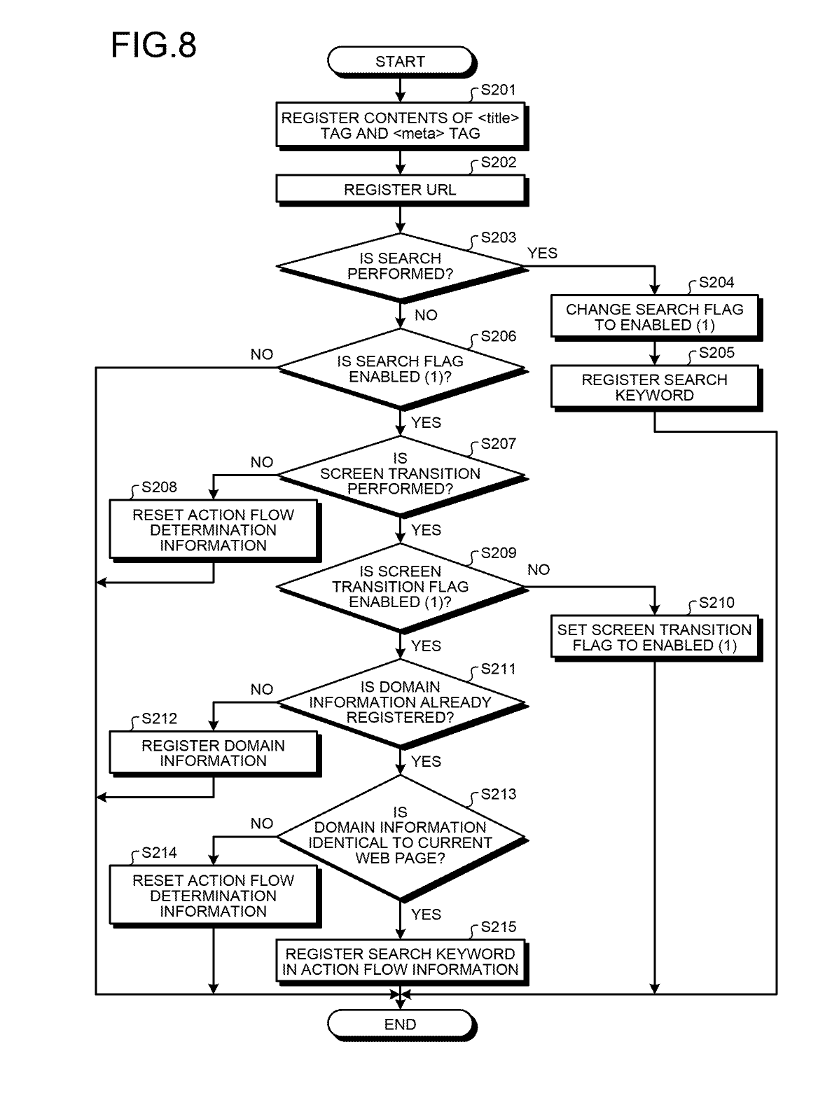

Next, the history registration process will be described. The process is performed at S106 in FIG. 7. FIG. 8 is a flowchart illustrating the flow of the history registration process.

As illustrated in FIG. 8, the page analyzing unit 18 extracts contents described in a <title> tag and contents described in a <meta> tag from a displayed website, and registers the contents in the history information DB 13b (S201). Subsequently, the page analyzing unit 18 acquires a URL of the website and registers the URL in the history information DB 13b (S202).

Thereafter, the history analyzing unit 19 determines whether a search is performed (S203). If a search is performed (YES at S203), the history analyzing unit 19 changes the search flag in the determination information DB 13a to enabled (1) (S204). Subsequently, the history analyzing unit 19 acquires a search keyword used for the search, and registers the search keyword in the search keyword in the determination information DB 13a (S205).

In contrast, when determining that a search is not performed (NO at S203), the history analyzing unit 19 determines whether the search flag is enabled (S206). If the search flag is disabled (NO at S206), the history analyzing unit 19 terminates the process. In contrast, if the search flag is enabled (YES at S206), the history analyzing unit 19 determines whether screen transition is performed (S207). If the screen transition is not performed (NO at S207), the history analyzing unit 19 resets the action flow determination information (S208). For example, if the web browser is closed, the history analyzing unit 19 initializes the determination information DB 13a.

Furthermore, if the screen transition is performed (YES at S207), the history analyzing unit 19 determines whether the screen transition flag in the determination information DB 13a is enabled (S209). If the screen transition flag in the determination information DB 13a is set to disabled “0”, rather than being enabled (NO at S209), the history analyzing unit 19 sets the screen transition flag to enabled “1” (S210).

In contrast, if the screen transition flag in the determination information DB 13a is enabled (YES at S209), the history analyzing unit 19 determines whether domain information is already registered in the determination information DB 13a (S211). If domain information is not registered in the determination information DB 13a (NO at S211), the history analyzing unit 19 acquires domain information from the displayed website and registers the domain information in the domain information in the determination information DB 13a (S212).

Furthermore, if domain information is already registered in the determination information DB 13a (YES at S211), the history analyzing unit 19 determines whether the registered domain information and the domain information of the currently-displayed website are identical (S213).

If the domain information is not identical (NO at S213), the history analyzing unit 19 determines that transition to a less-related website has been performed, and resets the action flow determination information (S214).

In contrast, if the domain information is identical (YES at S213), the history analyzing unit 19 determines that transition to a highly-related website has been performed, and registers the search keyword in the action flow information in the history information DB 13b (S215).

Search Process

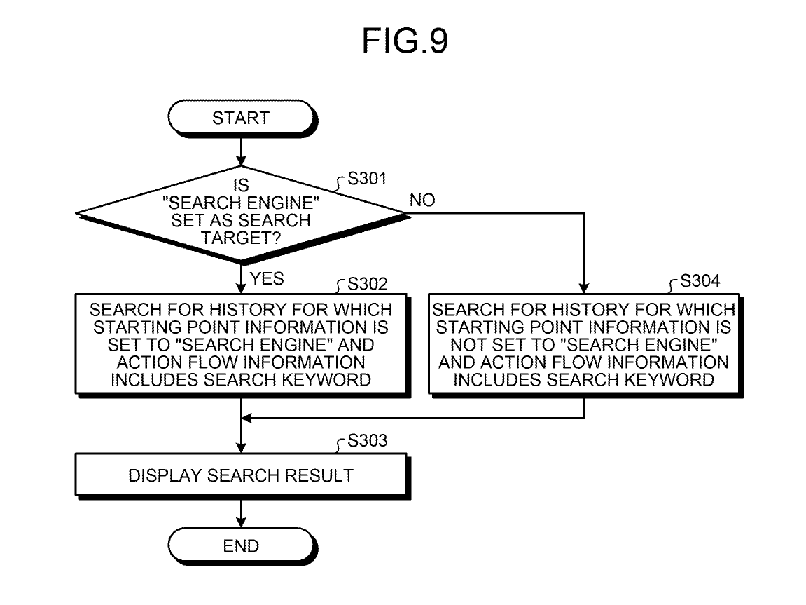

Next, a process of searching for a browsing history will be described. FIG. 9 is a flowchart illustrating the flow of the search process.

As illustrated in FIG. 9, if a “search engine” is set as a search target (YES at S301), the searching unit 20 searches for a history for which the starting point information is set to the “search engine” and the action flow information includes a search keyword (S302). Subsequently, the searching unit 20 displays a search result (S303).

In contrast, if a “search engine” is not set as a search target (NO at S301), the searching unit 20 searches for a history for which the action flow information includes the search keyword among histories for which the starting point information is not set to the “search engine” (S304). Subsequently, the searching unit 20 displays a search result (S303).

Effects

The above-described information processing apparatus 10 can provide an interface for searching for an appropriate website based on an associated keyword even when the number of browsed websites is increased and the websites are not appropriately classified by a user operation. Furthermore, the information processing apparatus 10 can provide, via a web browser, an appropriate browsing history based on an associated keyword, without regard to when the browsing history was referred to. Moreover, the information processing apparatus 10 can provide, via a web browser, a website that is referred to based on a keyword input in a search engine at the time of browsing.

As described above, the information processing apparatus 10 can register, in a history, a search keyword that a user has used to search for a website. Furthermore, the information processing apparatus 10 can register, in the history, a name of an application by which the user has displayed the website. Therefore, the information processing apparatus 10 can generate a history associated with an operation performed by the user, and the user can search for a browsing history by using own word or own operation as a key. As a result, the convenience of the user can be improved.

Incidentally, meta-information is embedded on a voluntary basis. Therefore, there is a website in which meta-information is not embedded. In contrast, a character string of a URL may include a keyword written in alphabets. In addition, the character string can include Japanese because of the popularization of internationalized domain (Internationalized Domain Names (IDN)). Therefore, by setting the URL as a search target, it becomes possible to provide a more accurate search result to the user. This is useful when a search engine is not used and a website is displayed by directly inputting a URL, and if the website does not include meta-information.

### [b] Second Embodiment

While the embodiment of the disclosed technology has been explained above, the present invention may be embodied in various forms other than the embodiment as described above.

History Information

In the above-described embodiment, an example has been described in which the starting point information and the action flow information are separately stored; however, it is not limited thereto. The starting point information and the action flow information may be stored in a single area. Furthermore, the starting point information may be divided into a search engine and others. Moreover, a timing of storing the history information may be arbitrary, such as a timing at which a website is displayed on a web browser or a timing at which an operation, such as bookmarking, is performed.

Search Process

In the above-described embodiment, an example has been described in which a search engine and an application are selected by a pull-down menu when a browsing history is searched for; however, it is not limited thereto. For example, the search engine and the application may be input by a user, or other menus may be used. Furthermore, it may be possible to use all pieces of history information as search targets without specifying a search engine and an application. Moreover, it may be possible to include a history of transitions in a result by using the order of transition included in the history information DB 13b. If a plurality of action flows are present, it may be possible to display the same number of search results as the action flows. Incidentally, the screen transition or the like explained in the above-described embodiment includes transition of screens of a web browser from a first web page to a second web page, or display of the second web page selected in the first page by using a new tag of the web browser (movement of a web page).

System

The components of the apparatuses illustrated in the drawings need not necessarily be physically configured in the manner illustrated in the drawings. That is, the components may be distributed or integrated in arbitrary units. Furthermore, for each processing function performed by each apparatus, all or any part of the processing function may be implemented by a CPU and a program analyzed and executed by the CPU or may be implemented as hardware by wired logic.

Moreover, of the processes described in the embodiments, all or part of a process described as being performed automatically may also be performed manually. Alternatively, all or part of a process described as being performed manually may also be performed automatically by known methods. In addition, the processing procedures, control procedures, specific names, and information including various kinds of data and parameters illustrated in the above-described document and drawings may be arbitrarily changed unless otherwise specified.

Hardware

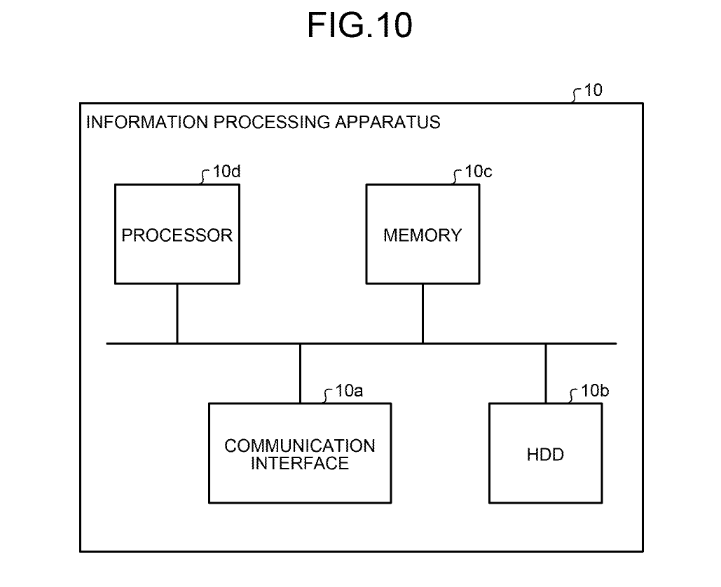

FIG. 10 is a diagram for explaining a hardware configuration example. As illustrated in FIG. 10, the information processing apparatus 10 includes a communication interface 10a, a hard disk drive (HDD) 10b, a memory 10c, and a processor 10d. The components illustrated in FIG. 10 are connected to one another via a bus or the like.

The communication interface 10a is an interface that controls communication with other devices, and is, for example, a network interface card. The HDD 10b stores therein a program for implementing the functions illustrated in FIG. 2 or the like, a DB, a table, and the like.

The processor 10d reads a program for executing the same process as the process performed by each of the processing units illustrated in FIG. 2 or the like from the HDD 10b or the like, loads the program on the memory 10c, and runs the process that implements the functions described with reference to FIG. 2 or the like.

That is, the process performs the same functions as the functions of each of the processing units included in the information processing apparatus 10. Specifically, the processor 10d reads, from the HDD 10b or the like, a program having the same functions as those of the operation input unit 16, the web processing unit 17, the page analyzing unit 18, the history analyzing unit 19, and the searching unit 20. Then, the processor 10d executes a process that performs the same processes as those of the operation input unit 16, the web processing unit 17, the page analyzing unit 18, the history analyzing unit 19, and the searching unit 20.

As described above, the information processing apparatus 10 operates as an information processing apparatus that implements a web access method by reading and executing the program. Furthermore, the information processing apparatus 10 can implement the same functions as those of the above-described embodiment by reading the above-described program from a recording medium by using a medium reading device and executing the read program. Incidentally, the program described in the embodiments need not necessarily be executed by the information processing apparatus 10. For example, the disclosed technology is applicable even when other computers or servers execute the program or even when other computers and servers execute the program in cooperation with each other.

According to an embodiment of the present invention, it is possible to improve the convenience for a user to access a website that has been accessed in the past.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein an access information storing program that causes a computer to execute a process comprising:
acquiring page information related to a web page displayed on a web browser;
generating starting point information related to an access to the web page, from access information of a series of web pages that are accessed and displayed on the web browser through the web page; and
storing page information of the web page associated with the starting point information.

2. The non-transitory computer-readable recording medium according to claim 1, wherein the generating includes generating, as the starting point information, a search word input in a search engine displayed on the web browser.

3. The non-transitory computer-readable recording medium according to claim 1, wherein generating includes generating, as the starting point information, information indicating whether the web browser is activated by a search engine that searches for the web page or by a different application.

4. The non-transitory computer-readable recording medium according to claim 1, wherein the generating includes generating the starting point information when the web page has a same domain as a web page obtained before transition or movement, and preventing generation of the starting point information when the web page has a different domain as the web page obtained before transition or movement.

5. A web access method comprising:
acquiring page information related to a web page displayed on a web browser, using a processor;
generating starting point information related to an access to the web page, from access information of a series of web pages that are accessed and displayed on the web browser through the web page, using the processor; and
storing page information of the web page associated with the starting point information, using the processor.

6. A web access device comprising:
a memory; and
a processor that is connected to the memory, wherein the processor executes a process including:
acquiring page information related to a web page displayed on a web browser;
generating starting point information related to an access to the web page, from access information of a series of web pages that are accessed and displayed on the web browser through the web page; and
storing therein page information of the web page associated with the starting point information in the memory.
